(19) United States
(12) Patent Application Publication
(10) Pub. No.: US 2011/0053030 A1
(43) Pub. Date: Mar. 3, 2011

(54) Fuel Cell with Gas Diffusion Layer having Flow Channel and Manufacturing Method Thereof

(75) Inventors: Young-Jun Sohn, Daejeon (KR); Minjin Kim, Daejeon (KR); Gu-Gon Park, Daejeon (KR); Seok-Hee Park, Daejeon (KR); Sung-Dae Yim, Daejeon (KR); Tae-Hyun Yang, Daejeon (KR); Young-Gi Yoon, Daejeon (KR); Won-Yong Lee, Daejeon (KR); Chang-Soo Kim, Incheon (KR)

(73) Assignee: KOREA INSTITUTE OF ENERGY RESEARCH, Daejeon (KR)

(21) Appl. No.: 12/870,359

(22) Filed: Aug. 27, 2010

(30) Foreign Application Priority Data
Sep. 3, 2009 (KR) 10-2009-0083208

(51) Int. Cl. H01M 8/24; H01M 2/14; H01M 8/04; H01M 8/00

(52) U.S. Cl. 429/455; 429/516; 429/452; 429/535

(57) ABSTRACT

Provided are a fuel cell with a porous gas diffusion layer having a flow channel and a method for manufacturing the same. A metal separator without a flow channel is used, but a flow channel for providing a reaction gas is formed in a gas diffusion layer made of a porous material. This improves precision of stack manufacturing and allows free design of the cooling part.

The gas diffusion layer is made of a porous metal material so as to maximize electrical transfer efficiency and improve endurance against physical stress.

### CROSS-REFERENCE TO RELATED APPLICATIONS

This application claims priority under 35 U.S.C. §119 to Korean Patent Application No. 10-2009-0083208, filed on Sep. 3, 2009, in the Korean Intellectual Property Office, the disclosure of which is incorporated herein by reference in its entirety.

### TECHNICAL FIELD

The following disclosure relates to a porous gas diffusion layer having a flow channel, a fuel cell with the porous gas diffusion layer having a flow channel and a method for manufacturing the same. More particularly, a metal separator without a flow channel is used, but a flow channel for providing a reaction gas is formed in a gas diffusion layer made of a porous material. This improves precision of stack manufacturing and allows free design of the cooling part.

The disclosure also relates to a fuel cell with a gas diffusion layer made of a porous metal material so as to maximize electrical transfer efficiency and improve endurance against physical stress.

### BACKGROUND

A fuel cell is a device that generates electricity through electrochemical reaction between hydrogen and oxygen. With such advantages as high efficiency, high current density and output density, short startup time and fast response to load change as compared to other power sources, it is widely applicable as power source of zero-emissions vehicles, private power generation, and mobile or military applications.

Referring to FIG. 1, a fuel cell has a membrane electrode assembly (MBA) in its innermost location. The membrane electrode assembly consists of an electrolyte membrane capable of conducting protons, and catalysts layer applied on both sides of the electrolyte membrane to allow reaction of oxygen and hydrogen, i.e. a cathode and an anode. At the outer portion of the membrane electrode assembly, i.e. at the outside of the cathode and the anode, are provided gas diffusion layers (GDLs). And, separators equipped with flow channels to allow supply of fuel and discharge of water produced by the reaction are provided outside the gas diffusion layers.

At the anode of the fuel cell, hydrogen is oxidized and, as a result, a proton and an electron are produced. The proton and the electron travel to the cathode through the electrolyte membrane and a wire, respectively. Simultaneously, at the cathode, oxygen is reduced by accepting the proton and the electron from the anode to produce water. Electrical energy is generated by the electron traveling through the wire and the proton traveling through the electrolyte membrane.

Conventionally, the separator has been manufactured by machining and molding of a carbon-based material and/or a synthetic resin. Such a separator made of a carbon-based material has a flow channel formed by machining. As seen in FIG. 2, the carbon-based separator 20 consists of a membrane electrode assembly 10 sandwiched by gas diffusion layers 30, and has cooling flow channels and reaction gas flow channels. However, the carbon-based separator is costly and is associated with other problems, including low thermal and electrical transfer efficiency and difficulty of making the separator as a thin plate due to low strength. Further, thus manufactured separator does not have good impact resistance.

To solve these problems, a metal plate (about 0.1 to 0.2 mm thick) having superior strength and easy to be made as a thin plate is used to manufacture the separator. As illustrated in FIG. 3, a metal separator 20 having a reaction gas flow channel and a cooling flow channel is manufactured by, for example, by pressing a metal plate. Such a metal plate 20 is advantageous in that manufacturing time and cost can be remarkably decreased as compared to the carbon-based separator whose flow channel is manufactured by machining.

However, the metal separator is limited in applications in terms of conformation because the cooling flow channel and the reaction gas flow channel are formed to be symmetrical to each other. Further, because of severe dimensional error of the plate, a satisfactory precision is not attained when hundreds of unit fuel cells are stacked.

### SUMMARY

An embodiment of the present invention is directed to providing a metal separator having good impact resistance with a flow channel for supplying a reaction gas formed in a gas diffusion layer made of a porous material, not in the separator. This improves precision of fuel cell stack manufactured and allows free design of the cooling part.

The employment of a porous metal material in the gas diffusion layer maximizes electrical transfer efficiency and improves endurance against physical stress.

Further, an optimized, free design of the cooling part may be attained by providing, for example, a cooling plate between the stacked plate separators.

In one general aspect, the present invention provides a gas diffusion layer for a fuel cell having a flow channel of a reaction gas formed on a surface of one side of the gas diffusion layer.

The gas diffusion layer may be made of a metal material.

The gas diffusion layer may have a microporous layer on the other side of the gas diffusion layer.

In another general aspect, the present invention provides a fuel cell stack formed by the stacking of unit fuel cells, each of which comprising: a membrane electrode assembly; gas diffusion layers provided on both sides of the membrane electrode assembly; and plate separators respectively provided at the outermost sides

A cooling plate may be provided between the separators of the adjacent unit cells.

The fuel cell stack may include an inlet portion formed at the cooling plate and communicated with manifolds for a reaction gas to guide the flow of the reaction gas; and an inlet hole formed at the separator so that the reaction gas guided by the inlet portion flows through the separator and is transferred to a reaction gas flow channel of the gas diffusion layer.

In another general aspect, the present invention provides a method for manufacturing a fuel cell stack formed by the stacking of unit fuel cells, each of which comprising: a membrane electrode assembly; a gas diffusion layer provided on either side of the membrane electrode assembly; and plate separators provided at the outermost side, comprising preparing the gas diffusion layer by pressing a plate of a porous material to form a flow channel for a reaction gas on one surface of the gas diffusion layer.

The plate of a porous material may be made of a metal material.

The method for manufacturing a fuel cell stack may include manufacturing a separator assembly by providing a cooling plate between the separators of the adjacent unit cells and bonding the same to form a cooling part between the unit cells.

An inlet portion may be formed at the cooling plate and communicated with manifolds for a reaction gas to guide the flow of the reaction gas; and an inlet hole may be formed at the separator so that the reaction gas guided by the inlet portion flows through the separator and is transferred to a reaction gas flow channel of the gas diffusion layer.

The fuel cell according to the present invention has improved precision because the irregularity in size resulting from the pressing process of the metal plate separators is eliminated and porosity of the gas diffusion layer eliminates irregularity in size during stacking .

Since a porous material is used for the gas diffusion layer, little dimensional error occurs while the reaction gas flow channel is formed by pressing. Further, the cost of manufacturing an expensive mold may be saved since high-pressure pressing is unnecessary.

Conventionally, there was a problem in that the water produced at the portion of the gas diffusion layer where the separator flow channel is in contact with the rib is not discharged well as compared to the flow channel side. However, in accordance with the present invention, since the flow channel and the rib are formed in the porous gas diffusion layer, the water produced at the rib is easily discharged through the flow channel and the risk of flooding is decreased.

Especially, as the gas diffusion layer is made of a porous metal material and the separator is made of a metal plate, thermal and electrical transfer efficiency is enhanced and impact resistance is improved. And, when compared with the existing gas diffusion layer made of carbon fiber, endurance against physical stress resulting from the freezing and thawing of water is improved.

Since the pressing work to form the reaction gas flow channel in the separator is unnecessary, the cooling parts to independently cool the unit fuel cells may be provided between the separators. Thus, a more effective thermal control of the fuel cell is possible.

Other features and aspects will be apparent from the following detailed description, the drawings, and the claims.

### BRIEF DESCRIPTION OF THE DRAWINGS

FIG. 1 shows a basic configuration of a fuel cell.

FIGS. 2 and 3 show an conventional separator.

FIG. 4 schematically shows a fuel cell stack according to an embodiment of the present invention.

FIG. 5 is an enlarged cross-sectional view along line A-A′ of FIG. 4.

FIG. 6 shows a gas diffusion layer of a fuel cell according to an embodiment of the present invention.

FIGS. 7 and 8 show a separator assembly of a fuel cell according to an embodiment of the present invention before and after assembling respectively.

FIG. 9 shows the flow of a reaction gas in a fuel cell according to an embodiment of the present invention.

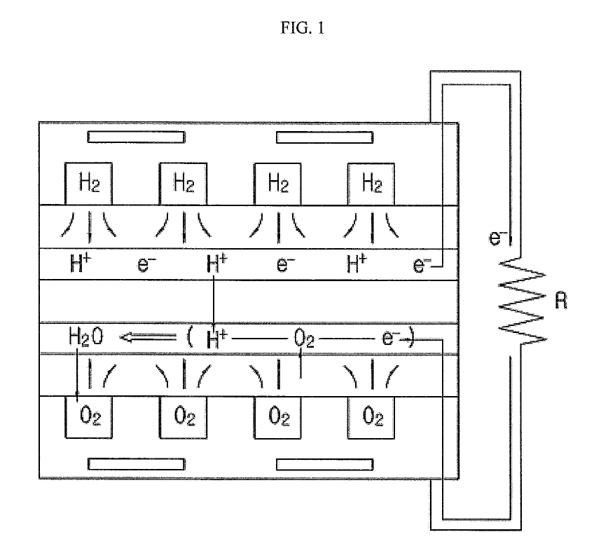

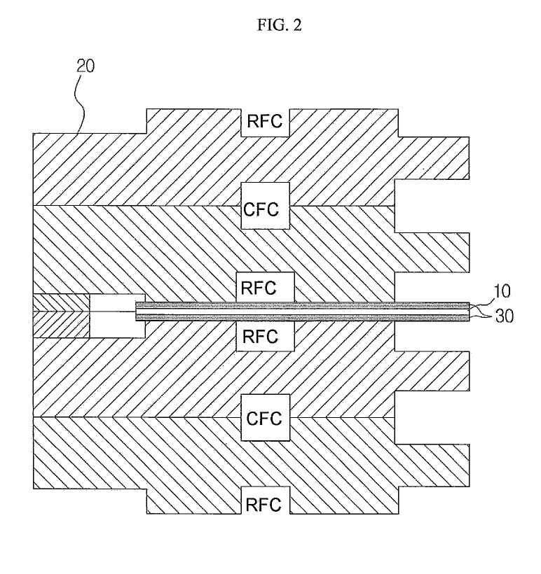

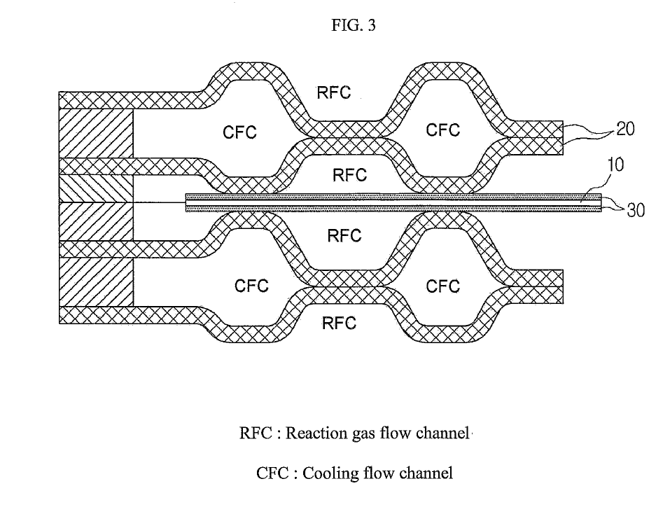

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments of a fuel cell with a porous gas diffusion layer 300 having a flow channel and a method for manufacturing the same will be described in detail with reference to the accompanying drawings.

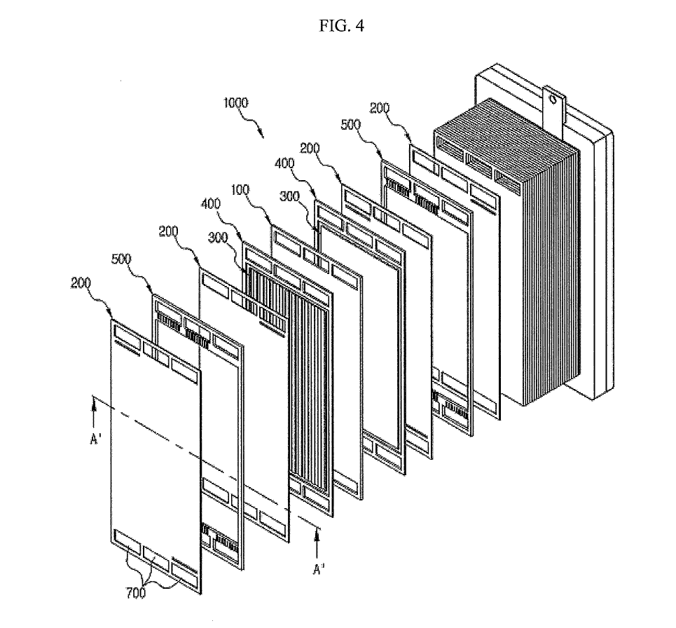

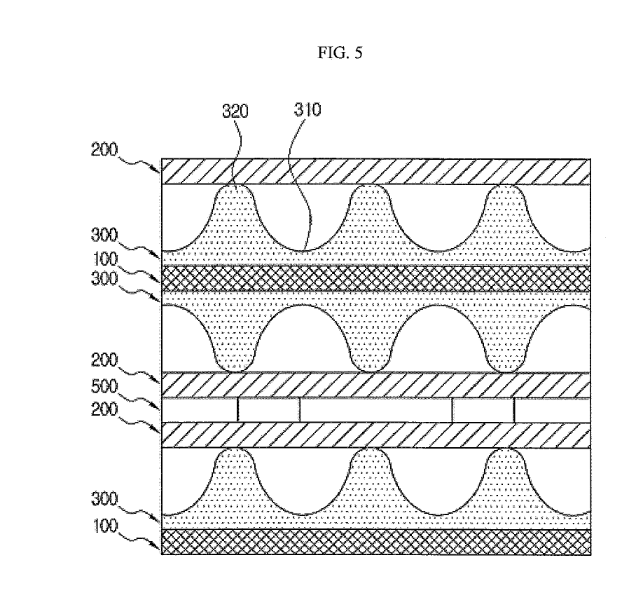

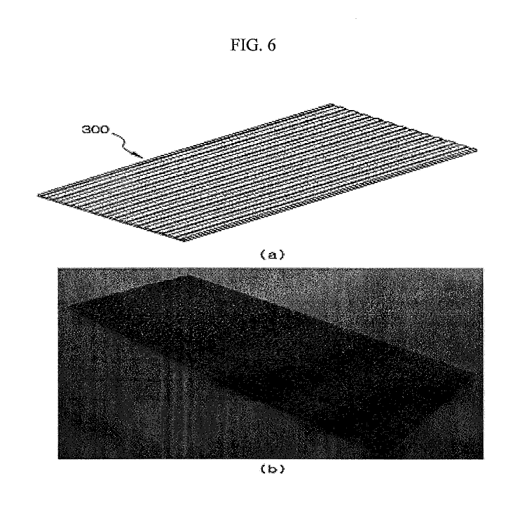

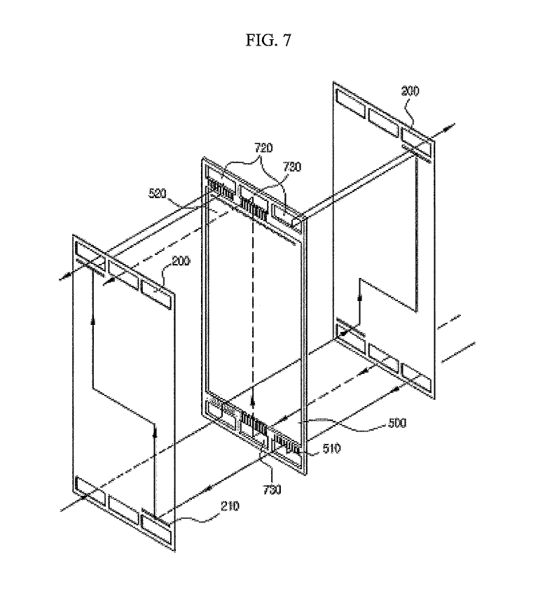

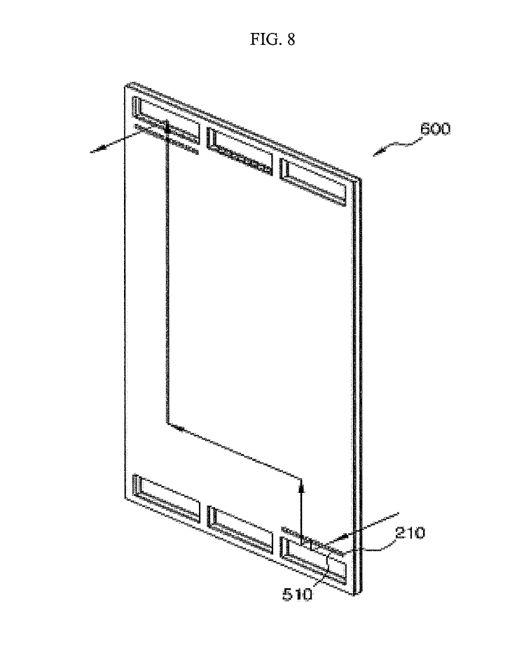

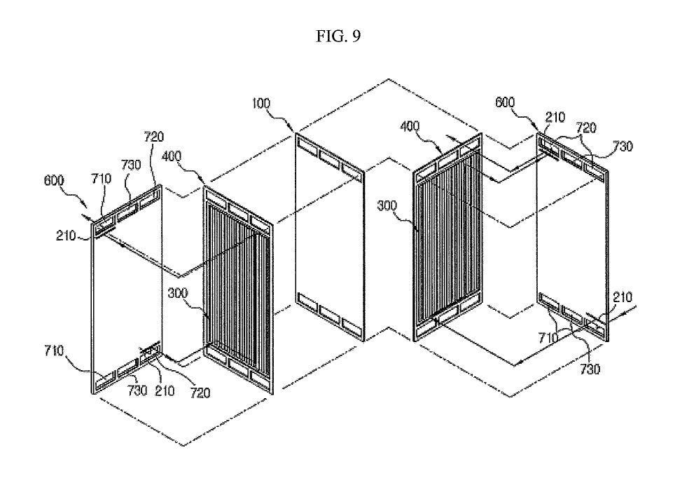

FIG. 4 schematically shows a fuel cell stack 1000 according to an embodiment of the present invention. FIG. 5 is an enlarged cross-sectional view along line A-A′ of FIG. 4. FIG. 6 shows a gas diffusion layer 300 of a fuel cell according to an embodiment of the present invention. FIGS. 7 and 8 show a separator assembly 600 of a fuel cell according to an embodiment of the present invention before and after assembling respectively. FIG. 9 shows the flow of a reaction gas in a fuel cell according to an embodiment of the present invention.

A fuel cell comprises a fuel cell stack 1000 formed by the stacking of unit fuel cells which generate electrical energy as the basic unit of the fuel cell. FIG. 4 schematically shows the stack 1000 formed as the unit cells are stacked. Each unit cell comprises: a membrane electrode assembly 100; gas diffusion layers 300 provided on both sides of the membrane electrode assembly 100; and plate separators 200 respectively provided at the outermost sides.

The membrane electrode assembly 100 comprises an electrolyte membrane which selectively passes protons only, and electrodes attached on both sides of the electrolyte membrane. On both sides of the membrane electrode assembly, gas diffusion layers 300 which transfer a reaction gas to the electrodes are provided. Outside the gas diffusion layers, i.e. at the outermost sides of the unit cell, separators 200 are provided to separate the unit cells.

When assembling the gas diffusion layer 300 with the separator 200, packing is used to prevent leakage of gas or water. Referring to FIG. 4, a gasket 400 is used to seal gas or liquid, maintain insulation between the plates, or the like. In general, in a fuel cell, a gasket 400 made of a fluorine-based rubber is used to provide chemical resistance or a performance-enhanced gasket 400 made of silicone is used.

When stacking the unit cells, a cooling means may be provided between the adjacent separators 200 to deal with the heat produced during oxidation-reduction reaction. Referring to FIG. 4, a cooling plate 500 is provided between the adjacent separators 200 to form a cooling part.

The configuration of the fuel cell stack 1000 according to the present invention will be described in more detail with reference to the cross-sectional view of FIG. 5. A flow channel for a reaction gas is formed by pressing on one side of the gas diffusion layer 300 provided outside of the membrane electrode assembly 100. At the outside of the gas diffusion layer 300, the plate separator 200 is provided without any processing. That is to say, whereas a flow channel for a reaction gas is formed by processing the separator 200 in the conventional art, the flow channel for a reaction gas of the present invention is formed in the gas diffusion layer 300, not in the separator 200. Since the separator 200 needs no additional processing, the space between the adjacent separators 200 may be freely designed as a cooling part.

The gas diffusion layer 300 allows diffusion of the fluid supplied into the fuel cell through a reaction gas flow channel 310 to a catalyst layer and allows diffusion of the fluid produced from electrochemical reaction through a discharge flow channel. It also serves to transfer the electrons produced from the electrochemical reaction. Accordingly, high electrical conductivity, chemical stability, porosity, or the like are important factors of the gas diffusion layer 300. Conventionally, porous materials having a porosity of about 50 to 90%, such as carbon paper, carbon cloth, carbon felt, or the like, have been used.

In the present invention, as illustrated in FIG. 6, the flow channel for a reaction gas is formed on a surface of the porous material itself. Since a porous material is used, a dimensional error hardly occurs even when pressing is performed to form the flow channel. Further, the, production cost can be saved because the high-pressure pressing of the separator 200 is unnecessary.

The reaction gas flow channel 310 formed on the gas diffusion layer 300 has grooves and ribs 320. Discharge of the water produced from oxidation-reduction reaction in the fuel cell is important in determining the overall performance of the fuel cell. In the conventional art, although water is discharged along the flow channel formed in the separator 200, the water at the rib 320 of the separator 200 is not discharged efficiently as compared to the flow channel side. However, in the present invention, since the flow channel and the rib are formed on the porous gas diffusion layer, the water at the rib is easily discharged through the flow channel. As a result, the risk of flooding decreases.

The gas diffusion layer 300 may be made of a porous metal material such as nickel foam, as illustrated in (b) of FIG. 6. As the gas diffusion layer 300, as well as the separator 200, is made of a metal material, thermal/electrical transfer efficiency is maximized and impact resistance is improved. Use of the porous metal material also results in improved endurance against physical stress resulting from the freezing and thawing of water as compared to the existing carbon material.

Like the existing carbon-based gas diffusion layer with no flow channel, the gas diffusion layer according to the present invention may comprise a microporous layer (not shown in the figure) to improve electrical connection between the gas diffusion layer and the membrane electrode assembly and to allow easier control of water. For example, the microporous layer may be prepared by filling conductive carbon powder or carbon black powder on the opposite side of the side where the reaction gas flow channel is formed. In this case, the gas diffusion layer may be made of either a carbon material or a metal material.

As the reaction gas flow channel 310 is formed on one surface of the gas diffusion layer 300, the separator 200 needs not be processed, and a cooling part may be designed between the separators 200 of the unit cells as occasion demands. Since the design of the cooling part is not restricted, it may be freely designed as water-cooling type or air-cooling type. The cooling part may be formed, for example, by inserting the cooling plate 500 on the separator 200 of the unit cell and then providing a plate with a cooling fluid flow channel or a netted mesh on the cooling plate to allow the flow of cooling water, or by inserting an air-cooling plate having protrusions such as a heatsink pin.

In the present invention, a cooling plate 500 with a water-cooling flow channel 520 as illustrated in FIG. 7 is used. The existing cooling flow channel 520 is restricted in designing an optimized cooling flow channel because it is formed symmetrically with the reaction gas flow channel 310 on the opposite side by pressing the separator 200. In contrast, in the present invention, since the cooling plate 500 is used independently of the reaction gas flow channel 310, the cooling flow channel 520 may be designed independently to effectively eliminate the reaction heat.

In accordance with the present invention, an inlet portion 510 is formed at the cooling plate 500 and communicated with manifolds 710, 720 for supplying and discharging the reaction gas to guide the flow of the reaction gas. And, an inlet hole 210 is formed at the separator 200 so that the reaction gas guided by the inlet portion 510 flows through the separator 200 and is transferred to a reaction gas flow channel 310 of the gas diffusion layer 300.

To describe in detail referring to FIGS. 4, 7 and 8, the stack 1000 is provided with a manifold 700 for supplying and discharging the reaction gas and the cooling fluid. In the present invention, the manifold 700 is formed integrally in the stack 1000. Each manifold 700 is formed through and at the same position of the membrane electrode assembly 100, the gasket 400, the separator 200 and the cooling plate 500. A supply manifold 710 for supplying the reaction gas and a discharge manifold 720 for discharging the reaction gas are respectively formed at both ends of the membrane electrode assembly 100, the gasket 400, the separator 200 and the cooling plate 500. Likewise, cooling manifolds 730 for supplying and discharging the cooling fluid are respectively formed at both ends of the same elements.

In the present invention, since the gas diffusion layer 300 with no manifold 700 is provided with the reaction gas flow channel 310, it is necessary to allow flow of the reaction gas between the reaction gas flow channel 310 and the supply manifold 710 and between the reaction gas flow channel 310 and the discharge manifold 72 respectively. To this end, the inlet portion 510 is provided in the cooling plate 500. The inlet portion 510 is formed to be communicated with the manifolds 710, 720 to guide the flow of the reaction gas.

The inlet hole 210 is formed in the separator 200, at a location corresponding to the inlet portion 510, so that the reaction gas guided by the inlet portion 510 flows through the separator 200 and is transferred to a reaction gas flow channel 310 of the gas diffusion layer 300.

Following the solid lines in FIGS. 7 and 9, which represent the flow of the reaction gas, the reaction gas flows along a path formed by the supply manifold 710, the inlet portion 510 and the inlet hole 210 and is transferred to the reaction gas flow channel 310 of the gas diffusion layer. After reaction, the resulting byproduct flows backward along a path formed by the reaction gas flow channel 310, the inlet hole 210, the inlet portion 510 and the discharge manifold 720 and is discharged out of the stack 1000. The flow of the reaction gas illustrated in FIGS. 7 and 9 is only exemplary, and may be modified in various manners if necessary. The inlet hole 210 and the inlet portion 510 may also be changed according to such modifications to allow the flow of the reaction gas.

If the flow of the reaction gas is guided using the cooling plate 500 as described above, it is necessary only to form the manifolds and the inlet hole 210 in the plate separator 200. Accordingly, the high-pressure pressing needed to form the cooling flow channel in the conventional art is unnecessary. As a result, the cost of manufacturing an expensive mold is saved and the occurrence of dimensional error in the pressing work is eliminated.

Hereinafter, a procedure of manufacturing a fuel cell according to the present invention will be described. First, the membrane electrode assembly 100, the separator 200, the porous metal plate and the cooling plate 500 are prepared individually.

Then, the porous metal plate is pressed to form the flow channel for a reaction gas on one side. Also, the cooling flow channel 520 is formed on one or both sides of the cooling plate 500.

The cooling plate 500 with the cooling flow channel 520 formed is assembled in advance before stacking with the plate separator 200. FIGS. 7 and 8 show the views before and after assemblage. The cooling plate 500 is inserted between the two plate separators 200 each forming the outer surface of a unit cell to manufacture an integrated separator assembly 600.

Then, the separator assembly 600, the gasket 400, the gas diffusion layer 300, the membrane electrode assembly 100, and gasket 400 and the gas diffusion layer 300 are repeatedly stacked in that order between end plates (not shown in the figure) connected to various inlet and outlet ports of the fuel and cooling fluid, as illustrated in FIG. 4, to complete the fuel cell stack 1000.

While the present invention has been described with respect to the specific embodiments, it will be apparent to those skilled in the art that various changes and modifications may be made without departing from the spirit and scope of the invention as defined in the following claims.

What is claimed is:

1. A gas diffusion layer for a fuel cell having a reaction gas flow channel formed on one side of the gas diffusion layer.

2. The gas diffusion layer for a fuel cell according to claim 1, which is made of a metal material.

3. The gas diffusion layer for a fuel cell according to claim 2, which has a microporous layer on the other side of the gas diffusion layer.

4. A fuel cell stack formed by stacking unit fuel cells, each of which comprising: a membrane electrode assembly; the gas diffusion layers according to claim 1 provided on both sides of the membrane electrode assembly; and plate separators provided at the outermost sides.

5. The fuel cell stack according to claim 4, wherein a cooling plate is provided between the adjacent separators of the unit cells.

6. The fuel cell stack according to claim 5, which comprises: an inlet portion formed at the cooling plate and communicated with manifolds for a reaction gas to guide the flow of the reaction gas; and an inlet hole formed at the separator so that the reaction gas guided by the inlet portion flows through the separator and is transferred to the reaction gas flow channel of the gas diffusion layer.

7. A method for manufacturing a fuel cell stack formed by stacking unit fuel cells, each of which comprising: a membrane electrode assembly; gas diffusion layers provided on both sides of the membrane electrode assembly; and plate separators provided at the outermost sides, comprising preparing the gas diffusion layer by pressing a plate of a porous material to form a reaction gas flow channel on one side of the gas diffusion layer.

8. The method for manufacturing a fuel cell stack according to claim 7, wherein the plate of a porous material is made of a metal material.

9. The method for manufacturing a fuel cell stack according to claim 7, which comprises manufacturing a separator assembly by providing a cooling plate between the separators of the adjacent unit cells and bonding the same to form a cooling part between the unit cells.

10. The method for manufacturing a fuel cell stack according to claim 9, wherein an inlet portion is formed at the cooling plate and communicated with manifolds for a reaction gas to guide the flow of the reaction gas; and an inlet hole is formed at the separator so that the reaction gas guided by the inlet portion flows through the separator and is transferred to a reaction gas flow channel of the gas diffusion layer.
